(19) United States
(12) Patent Application Publication
(10) Pub. No.: US 2007/0078712 A1
(43) Pub. Date: Apr. 5, 2007

(54) Systems for inserting advertisements into a podcast

(75) Inventors: Edward Stanley Ott IV, Palo Alto, CA (US); Nathanael Joe Hayashi, Piedmont, CA (US)

Correspondence Address: James J. DeCarlo;GREENBERG TRAURIG, LLP, MetLife Building, 200 Park Avenue, New York, NY, 10166, US

(73) Assignee: Yahoo! Inc., Sunnyvale, CA (US)

(21) Appl. No.: 11/347,046

(22) Filed: Feb. 2, 2006

Related U.S. Application Data
(60) Provisional application No. 60/722,600, filed on Sep. 30, 2005.

(51) Int. Cl. G06Q 30/00

(52) U.S. Cl. 705/14

(57) ABSTRACT

Systems and methods are provided for automatically delivering media files with advertisements over a network. A method and system is disclosed for automatically adding an advertisement to the beginning or the end of a media file, such as a podcast episode, when the media file is requested by a consumer. In another aspect, the media file may be automatically searched for an advertisement marker, such as a specific tone or data element in the media file, that acts as a submission point for the automatic insertion of an advertisement into the media file. Aspects of the present invention allow for automatic insertion of advertisements after the creation of the media file, potentially without any interaction between the creator and the advertiser. The systems can be implemented at a central server, at the media file source, at a consumer's media player or distributed throughout various computing devices.

### RELATED APPLICATIONS

This application claims the benefit of U.S. Provisional Application No. 60/722,600, filed Sep. 30, 2005 which application is hereby incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The expansion of the Internet and the World Wide Web (“web”) has given computer users the enhanced ability to listen to and to watch various different forms of media through their computers. This media can be in the form of audio music, music videos, television programs, sporting events or any other form of audio or video media that a user wishes to watch or listen to.

Podcasting is a method of publishing digital media, typically audio programs, via the Internet, allowing users to subscribe to a feed of new files (e.g., .MP3s audio files). The word “podcasting” became popular in late 2004, largely due to automatic downloading of audio onto portable players or personal computers. Podcasting is distinct from other types of online media delivery because of its subscription model, which uses a “feed,” which may also be referred to as a “podcast,” to describe, identify and deliver an media file. A feed, in this context, refers to a list of files that can be easily interpreted to identify new files in the list as the files are added over time. Thus, one is said to subscribe to a feed because as new files are added to the list, the subscriber is notified of the new file and, in some cases, the new file is automatically delivered. The feed may exist as a discrete file, such as an .RSS file discussed below, or it may exist as part of a some other data format or element.

Podcasting enables independent producers to create self-published, syndicated media, such as “radio shows,” and gives broadcast news, radio, and television programs a new distribution method. Listeners may subscribe to feeds using “podcatching” software (a type of aggregator), which periodically checks for and downloads new content automatically. Most podcatching software enables the user to copy podcasts to portable music players. Most digital audio player or computer with audio-playing software can play podcasts. From the earliest RSS-enclosure tests, feeds have been used to deliver video files as well as audio. By 2005 some aggregators and mobile devices could receive and play video, but the “podcast” name remains most associated with audio. Other names are sometimes used for casting other forms of media, such as blogcasting for text and vcasting or vodcasting for video. For the purposes of this application, podcast is used in its most general sense to refer to a feed of new files in any format (e.g., .MP3, .MPEG, .WAV, .JPG) and containing any content (e.g., text-based, audible, visual or some combination) that can be subscribed to by a client. Also, for the purposes of this discussion an individual podcast may be referred to as a series, and each distinct new file in the series may be referred to as an individual episode of the series.

Podcasting is supported by underlying feed formats such as RSS. RSS is a family of XML file formats for web syndication used by (amongst other things) news websites and weblogs. The abbreviation is used to refer to the following standards: Rich Site Summary (RSS 0.91); RDF Site Summary (RSS 0.9 and 1.0); and Really Simple Syndication (RSS 2.0).

The technology behind RSS allows a client, in a client-server environment, to subscribe to RSS feeds on websites maintained by remote servers; these are typically sites that change or add content regularly. To use this technology the client needs some type of aggregation service or aggregator. The aggregator allows a client to subscribe to the podcasts that the client wants to get updates (i.e. future media files in the feed) on. Unlike typical subscriptions to pulp-based newspapers and magazines, your RSS subscriptions are free, but they typically only provide a line or two of each article or post along with a link to the full article or post.

The RSS formats provide web content or summaries of web content together with links to the full versions of the content, and other meta-data. This information is delivered as an XML file called RSS feed, webfeed, RSS stream, or RSS channel. In addition to facilitating syndication, RSS allows a website's frequent readers to track updates on the site using an aggregator.

A program known as a feed reader or aggregator can check RSS-enabled webpages on behalf of a user and display any updated articles that it finds. It is now common to find RSS feeds on major web sites, as well as many smaller ones. Client-side readers and aggregators are typically constructed as standalone programs or extensions to existing programs like web browsers. Such programs are available for various operating systems.

Podcasting has become a very popular and accepted media delivery paradigm. This success has caused the number and variety of podcasts available to clients to grow exponentially. Potential podcast consumers are now confronted with the problems of how to find podcasts, how to organize and manage their podcast subscriptions; and how to listen to episodes efficiently and easily. Podcast publishers are also confronted with problems including how to effectively market their podcasts, how to generate income from their podcasts, how to easily create and disseminate podcasts, how to support different feed formats and device needs, and how to manage bandwidth and storage costs.

Due to its popularity, various business interests are interested in using podcasting as a medium for advertising. Currently, advertisements are used in conjunction with podcasts and other media files in one of two ways, either advertisements are provided separately (such via “pop-up” windows) to consumers downloading a podcast episode or the advertisements are incorporated into the podcast episode itself. Both methods limit the ability of advertisers to effectively display their advertisements using this new medium; pop-up ads may be blocked and easily ignored and pre-created episodes can not be tailored to different target groups, modified over time, or otherwise changed to meet the needs of the ongoing advertiser. Although, this is a problem for the advertiser, it also represents a loss in potential revenue for the podcast publisher as well.

### SUMMARY OF THE INVENTION

The present invention relates to a system and method for delivering media files with advertisements over a network. In one aspect, the present invention includes a method and system for automatically adding an advertisement to the beginning or the end of a media file, such as a podcast episode, when the media file is requested by a consumer. In another aspect, the present invention includes a method and system for automatically searching the media file for an advertisement marker, such as a specific tone or data element in the media file, that acts as a submission point for the automatic insertion of an advertisement into the media file. In yet another aspect, the present invention includes a method and system in which a time-based tag that identifies the location to insert an advertisement is added by the media file creator. Aspects of the present invention allow for automatic insertion of advertisements after the creation of the media file, potentially without any interaction between the creator and the advertiser. The system can be implemented by adding the podcast and ad together at a central server, at the source of the podcast or the add or at a consumer's media player.

In one example (which example is intended to be illustrative and not restrictive), the present invention may be considered a method for providing an advertisement with a media file in which a computing device receives, from a requesting device, a request for a media file. The computing device then determines, based on the request, that an advertisement should be transmitted with the media file but that the media file does not include the advertisement. The computing device then automatically transmits the media file and the advertisement to the requesting device so that the media file and the advertisement are rendered in a continuous sequence. The media file may be modified to include the advertisement or a command to interrupt the rendering of the media file may be provided so that the media file and the advertisement are rendered in a predetermined sequence.

In another example (which example is intended to be illustrative and not restrictive), the present invention may be considered a computer-readable medium containing instructions for a computer-implemented method for automatically providing an advertisement with a media file in which a computing device receives, from a requesting device, a request for a media file. The computing device then determines, based on the request, that an advertisement should be transmitted with the media file but that the media file does not include the advertisement. The computing device then automatically transmits the media file and the advertisement to the requesting device so that the media file and the advertisement are rendered in a continuous sequence. The media file may be modified to include the advertisement or a command to interrupt the rendering of the media file may be provided so that the media file and the advertisement are rendered in a predetermined sequence.

In one example (which example is intended to be illustrative and not restrictive), the present invention may be considered a system for providing advertisements with media files so that the media data of the media files and advertisements are rendered consecutively with media data from the advertisement in a predetermined sequence. In the system, a request interception module adapted to receive a request for a media file and to inspect the request to determine if an advertisement is associated with the media file is provided. The system also includes a media file retrieval module adapted to retrieve the media file identified by the request. A transmission module is further provided that is adapted to create a response to the request, the response including the media file and, if an advertisement is associated with the media file; the associated advertisement, and to transmit the response, the response when rendered resulting in the rendering of the media file and the advertisement in a predetermined sequence.

In another example (which example is intended to be illustrative and not restrictive), the present invention may be considered a system for inserting advertisement markers into a media file in which the advertisement markers identify when relative to the media data in the media file an advertisement should be rendered. The system includes a media player for playing media files having a user interface and a means for generating and associating an advertisement marker with a media file. Upon rendering of the media file in the future, if an advertisement is been associated with the media file at the time of rendering, the rendering device will render both the media data from the media file and media data from the advertisement in a sequence determined by the advertisement marker.

In another example (which example is intended to be illustrative and not restrictive), the present invention may be considered a computer-readable medium for access by an application program executed on a rendering device that when rendered results in the rendering of both media data from a media file and media data from an advertisement in a predetermined sequence. The computer-readable medium includes at least one data structure stored on the computer-readable medium. The data structure includes first media data renderable by the rendering device and an advertisement marker identifying a location within the first media data to interrupt rendering of the first media data and to render an advertisement before resuming rendering of the first media data.

Additional features of the invention will be set forth in the description which follows, and in part will be apparent from the description, or may be learned by practice of the invention. The benefits and features of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 is a schematic illustrating an exemplary network architecture according to one embodiment of the present invention;

FIG. 2 is an illustration of an exemplified embodiment of an architecture for an advertisement insertion system;

FIG. 3 is an exemplary user interface of an exemplary podcast feed search engine as it would be displayed on a browser of a computing device according to one embodiment of the present invention.

FIG. 4 is an exemplary user interface showing the results of a podcast search according to an embodiment of the present invention;

FIG. 5 is a flowchart depicting an embodiment of a method for providing an advertisement with a media file in accordance with the present invention;

FIG. 6 is a flowchart depicting in greater detail an embodiment of a method for retrieving an advertisement and providing it with a media file in accordance with the present invention;

FIG. 7 is a flowchart depicting in greater detail yet another embodiment of a method for retrieving an advertisement and providing it with a media file in accordance with the present invention;

FIG. 8 is a flowchart depicting in greater detail yet another embodiment of a method for retrieving an advertisement and streaming media data from the advertisement and the requested media file in accordance with the present invention; and

FIG. 9 is an exemplary user interface for a media player adapted to insert advertisement markers into audio media files according to one embodiment of the present invention.

### DETAILED DESCRIPTION OF PREFERRED EMBODIMENTS

In general, the present invention relates to a system and method for delivering media files with advertisements over a network. As used herein, the terms “content”, “media”, or “media files” are used broadly to encompass any type or category of renderable, experienceable, retrievable, computer-readable filed and/or stored media, either singly or collectively, and individual items of media or content are generally referred to as entries, songs, tracks, pictures, images, items or files, however, the use of any one term is not to be considered limiting as the concepts features and functions described herein are generally intended to apply to any storable and/or retrievable item that may be experienced by a user, whether aurally, visually or otherwise, in any manner now known or to become known. Further, the term media includes all types of media such as audio and video.

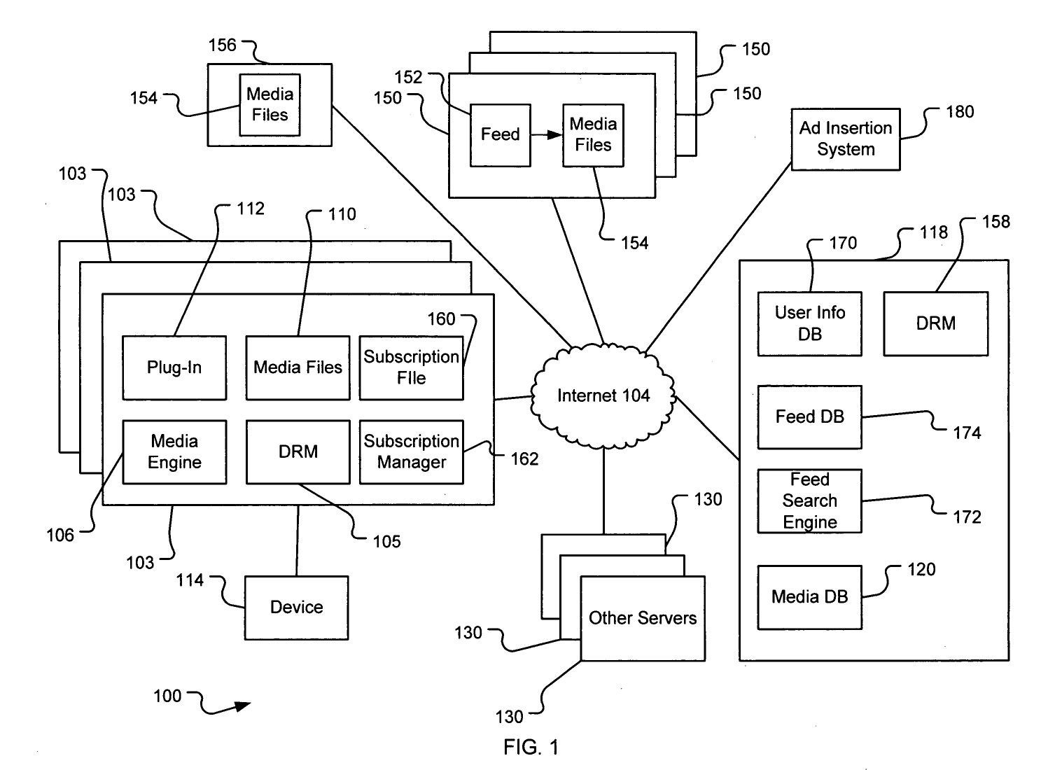

Embodiments of the present invention will now be discussed with reference to the aforementioned figures, wherein like reference numerals refer to like components. Referring now to FIG. 1, the architecture of one embodiment of the present invention is shown in schematic form. As can be seen in FIG. 1, a system 100 according to one embodiment of the present invention is shown. In general the system 100 allows users to experience, share and otherwise utilize different media. Although numerous exemplary embodiments will be discussed in terms of music and/or audio files, this invention can also be utilized with any form of audio, video, digital or analog media content, as well as any other media file type now known or to become known.

Each user utilizes a computing device or processor 103, such as personal computer (PC), web enabled cellular telephone, personal digital assistant (PDA) or the like, coupled to the Internet 104 by any one of a number of known manners. Furthermore, each processor 103 preferably includes an Internet browser (not shown), such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users. Each processor also includes a media engine 106 that, among other functions to be further described, provides the ability to convert information or data into a perceptible form and manage media related information or data so that user may personalize their experience with various media.

A media engine 106 may be incorporated into processor 103 by a vendor of processor 103, or obtained as a separate component from a media engine provider or in some other art recognized manner. As will be further described below, it is contemplated that media engine 106 may be a software application, or a software/firmware combination, or a software/firmware/hardware combination, as a matter of design choice, that serves as a central media manager for a user and facilitates the management of all manner of media files and services that the user might wish to access either through a computer or a personal portable device or through network devices available at various locations via a network. As used herein, the term media file is used generically to refer to an item of media, as well as associated metadata and/or network location information for that item. A processor 103 may also be referred to as a rendering device 103 to indicate that it is adapted to retrieve and render media files from the network.

Processor 103 also may include storage of local media files 110 and/or other plug-in programs 112 that are run through or interact with the media engine 106. In one embodiment, media files 110 are audio files. In another embodiment, media files are video files. In yet another embodiment, media files can be a combination file compatible with a MPEG-21 standard or the like. Processor 103 also may be connectable to one or more portable devices 114 such as a compact disc player and/or other external media file player, commonly referred to as an MP3 player, such as the type sold under the trade name iPod by Apple Computer, Inc., that is used to portably store and play media files.

Local files may be stored on a mass storage device (not shown) that is connected to the processor 103 or alternatively may be considered part of the processor 103. The mass storage device and its associated computer-readable media, provide non-volatile storage for the processor 103. Although the description of computer-readable media contained herein refers to a mass storage device, such as a hard disk or CD-ROM drive, it should be appreciated by those skilled in the art that computer-readable media can be any available media that can be accessed by the processor 103.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Additionally, processor 103 may contain Digital Rights Management software (DRM) 105 that protects the copyrights and other intellectual property rights of the user's media files by enabling secure distribution and/or preventing or hampering illegal distribution of the media files. In one embodiment, DRM 105 encrypts or decrypts the media files for controlled access by authorized users, or alternatively for marking the content with a digital watermark or similar method so that the content can not be freely distributed. Media engine 106 preferably uses the DRM information to ensure that the media files being experienced through media engine 106 are not copied to or shared with users that are unauthorized to listen to or view the content.

The processor 103 may include the software necessary to subscribe to podcasts. In the embodiment shown, the processor 103 includes a subscription file 160, such as an OPML file. The subscription file 160 maintains information that identifies what podcasts the user has subscribed to. The subscription file 160 may include a list of feeds 152 and the feed locations.

The processor 103 also includes a subscription manager 162. The subscription manager 162 can perform the podcatching functions of an aggregator and can periodically poll the feeds identified in the subscription file 160 to determine if new episodes of the podcast are available. Upon determination that a new episode is available, the subscription manager 162 may notify the user or may automatically download the episode to the processor, such as by retrieving it from a location, such as a media server 150, via the network 104.

The system 100 also includes subscription server 118. In addition to serving media over the Internet 104 to the user, subscription server 118 includes a media database 120, which in addition to storing the actual media files also stores or communicates with storage devices storing various metadata attributes associated with particular pieces of media. Database 120 may be distributed over multiple servers provided with mass storage devices or other forms of computer-readable media or contained in a large mass storage device accessible the subscription server 118. Other servers 130 make other content and services available and may provide administrative services such as managing user logon, service access permission, digital rights management, and other services made available through a service provider. Although some of the embodiments of the invention are described in terms of music, embodiments can also encompass any form of streaming or non-streaming media including but not limited to news, entertainment, sports events, web page or perceptible audio, video or image content. It should be also be understood that although the present invention is described in terms of media content and specifically audio content, the scope of the present invention encompasses any content or media format heretofore or hereafter known.

The subscription server 118 also includes a database 170 of user information. The user information database 170 includes information about users that is collected from users or generated by the subscription server 118 as the user interacts with the subscription server 118. In one embodiment, the user information database 170 includes user information such as user name, gender, e-mail and other addresses, user preferences, etc. that the user may provide to the subscription server 118. In addition, the server 118 may collect information such as what podcasts the user has subscribed to, what searches the user has performed, how the user has rated various podcasts, etc. In effect, any information related to the user and the podcasts that user subscribes to that is available to the subscription server 118 may be stored in the user information database 170.

The user information database 170 may also include information about a user's devices 114. The information allows the subscription server 118 to identify the device and differentiate it from the processor 103. Furthermore, it is anticipated that a single user may have multiple different processors 103 and each processor 103 may be associated with different information. For example, a user may subscribe to a news podcast on a mobile device such as a smart phone 103 or similar Internet connected mobile device 103 and may subscribe to a gaming podcast on a home computer 103. The user information database 170 contains all this information. In one embodiment, the user information database 170 may include the same information contained in the processor's subscription file 160 for each processor 103 associated with the user. The user information database 170 may even include one or more files in the OPML file format for each user.

In the embodiment shown, the subscription server 118 includes a feed database 174. The feed database 174 may include a list of podcasts known to the server 118. This list may be periodically refreshed as the server 118 searches for new feeds 152 and for feeds 152 that have been removed from access to the internet 104. Such a feed database 174 may not be necessary if the searching ability of the server 118 is sufficient to quickly provide user with updated and accurate feed information in response to a user search. The feed database 174 may include all of the information provided by the feed 152. In addition, the feed database 174 may include other information generated by the subscription server 118 or by users. Thus, the feed database 174 may contain information not known to or generated by the publisher of the feed 152.

In one embodiment, the databases 120, 174, 170 may be separate and distinct databases, while in an alternative embodiment some or all of the databases 120, 174, 170 may be combined into a single database. The databases 120, 174, 170 part of the server 118 or may be located on separate computing devices that are in communication with the server 118.

In an embodiment, the feed database 174 includes additional information regarding feeds 152 in the form of “tags.” A tag is a keyword chosen by a person accessing the subscription server 118 to describe a particular feed 152. The tag can be any word or combination of key strokes. Each tag submitted to the subscription server may be recorded in the feed database 172 and associated with the feed the tag describes. Tags may be associated with a particular feed 152 (e.g., a series tag) or associated with a specific media file 154 within the feed 152 (e.g., an episode tag). Tags will be discussed in greater detail below.

Since tags can be any keyword, a typical name for a category, such as “science” or “business,” may also be used as a tag and in an embodiment the initial tags for a feed are automatically generated by taking the category designations from a feed and using them as the initial tags for the feed. However, note that tags are not a hierarchical category system that one “drills down” through. Tags are not hierarchically related as is required in the typical categorization scheme. Tags are also cumulative in that the number of users that identify a series or an episode with a specific tag are tracked. The relative importance of the specific tag as an accurate description of the associated content (i.e., series or episode) is based on the number of users that associated that tag with the content.

In an embodiment, consumers of feeds 152 are allowed to provide information to be associated with feeds or with particular episodes of feeds. Thus, the user after consuming data may rate an episode, say on a scale of 1-5 stars, write a review of the episode, and enter tags to be associated with the episode. All this consumer-generated data may be stored in the feed database 174 and associated with the appropriate episode for use in future searches.

The subscription server 118 includes a search engine 172. In an embodiment, the search engine 172 performs multiple functions including crawling the network 104 to identify feeds and episodes of feeds on the network 104, retrieving feed information and storing it in the feed database 174, and providing a means for processors 103 to easily search the feed database 174 for feeds and episodes.

Because of their very nature, feeds 152 are expected to change over time through the addition of new media files 154 as episodes of the feed 152. In an embodiment, the search engine 172 periodically and automatically crawls the network 104 to find new feeds 152 and for previously identified feeds 152 that have changed since the last time the search engine 172 inspected the feed 152. When crawling the network 104, the search engine 172 can use any network searching or crawling methods, such as for example, the method for crawling information on a network described in commonly owned U.S. Pat. No. 6,021,409, titled “METHOD FOR PARSING, INDEXING AND SEARCHING WORLD-WIDE-WEB PAGES.” The search engine 172 creates one or more new entries in the feed database 174 for every new feed 152 it finds. Initially, the entry or entries contain the location of the feed, an identifier of the feed (such as its name), and some or all of the information contained in or otherwise provided by or associated with the feed 152. For example, for an RSS feed this information may include some or all of the metadata within the RSS feed file. This feed information is retrieved by the search engine 172 from the feed 152 and stored in the feed database 174 so that the feed database contains some or all of the information provided in the feed 152. Such information may include the feed description, episode descriptions, episode locations, etc.

An automatic analysis may or may not be performed to match the feed 152 to known tags based on the information provided in the feed 152. For example, in an embodiment some RSS feeds include a category element and the categories listed in that element for the feed are automatically used as the initial tags for the feed. While this is not the intended use of the category element, it is used as an initial tag as a starting point for the generation of more accurate tags for the feed. Note that client searches on terms that appear in the feed 152 will return that feed as a result, so it is not necessary to provide tags to a new entry for a client search to work properly. Initially no ratings information or user reviews are associated with the new entry. The manager of the subscription server may solicit additional information from the publisher such as the publisher's recommended tags and any additional descriptive information that the publisher wishes to provide but did not provide in the feed 152 itself.

The feed database 174 may also include such information as reviews of the quality of the feeds, including reviews of the series as a whole and reviews specific to each episode in a given feed 152. The review may be a rating such as a “star” rating and may include additional descriptions provided by users.

In addition to maintaining information specific to series and individual episodes within the series, the feed database 174 may also include information associated with publishers of the feeds, sponsors of the feeds and/or episodes, topics discussed in the feeds or episodes or people in the feeds or episodes.

The feed database 174 may also include information concerning advertisers and advertisements associated with feeds and episodes. For example, associated with each feed may be a set of one or more advertisers or advertisements. This information may then be used to select an advertisement to be transmitted or streamed to a consumer's processor 103 as will be described in greater detail below.

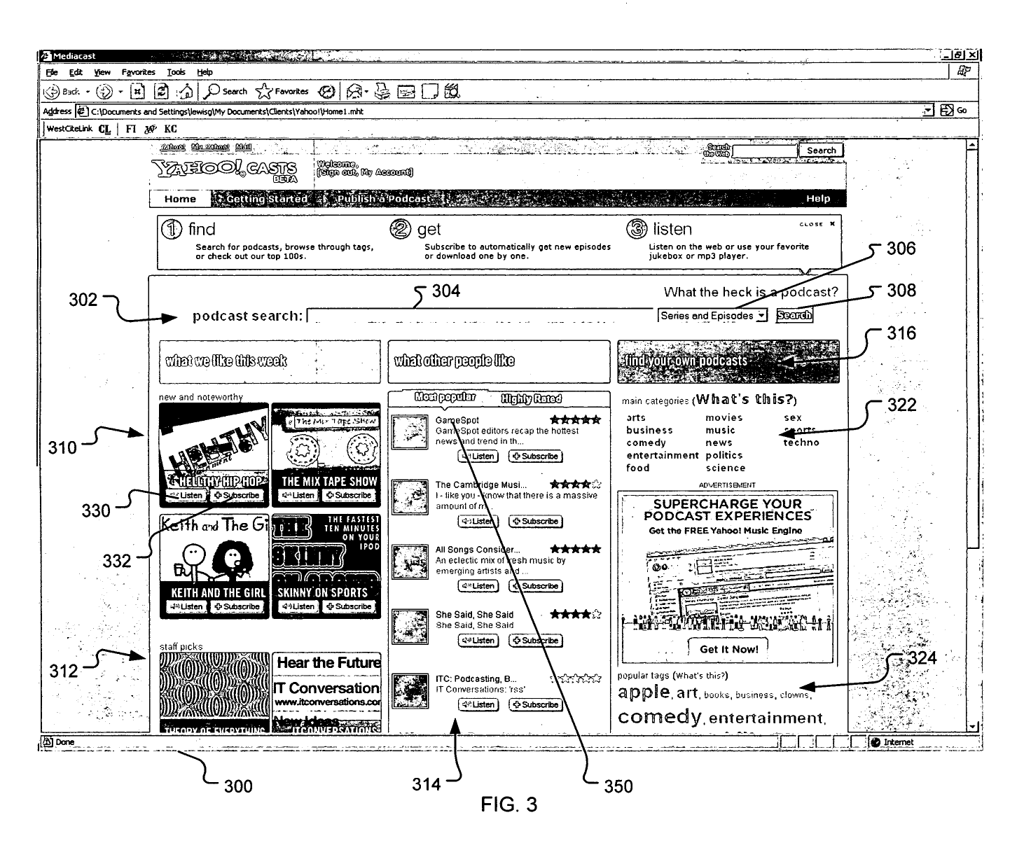

In order to facilitate client searches for podcasts, the feed search engine 172 provides a graphical user interface to user's processors 103 allowing the user to search for and subscribe to feeds 152 using the subscription server 118. In one embodiment, the graphical user interface may be an .HTML page served to a processor 103 for display to the user via a browser. Alternatively the graphical user interface may be presented to the user through some other software on the processor 103. An example of a graphical user interface presented to a user by a browser is discussed with reference to FIG. 3. Through the graphical user interface, the feed search engine 172 receives user search criteria. The search engine 172 then uses the search criteria as parameters to identify feeds 152 that meet the user's criteria. The search may include an active search of Internet 104, a search of the feed database 174, or some combination of both 174. The search may include a search of the descriptions provided in the feed 152 of the series and each particular episode in the series. The search may also include a search of the third party-provided tags, ratings, and reviews and other information associated with feeds 152 listed in the feed database 174 but not provided by the feeds 152 themselves. The results of the search are then displayed to the user.

In one embodiment of the present invention, similar to the DRM software 105 located on the user's processor 103, the subscription server may maintain its own DRM software 158 which tracks the digital rights of media files located either in the media database 120 or stored on a user's processor. Thus, for example, before the subscription server 118 streams or serves up or transfers any media files to a user, it validates the rights designation of that particular piece of media and only serves streams or transfers the file if the user has the appropriate rights. This may be determined by an inspection of information contained on the processor 103, in the user information database 170, or both.

The system 100 also includes a number of media servers 150, that are remote from the processors 103 and the subscription server 118, that publish podcasts. In one embodiment remote means remote in the logical, network sense in that each media server 150, each processor 103 and the subscription server 118 may be accessed using different domain names as their network locator, such as the Uniform Resource Locator (URL). For example, the subscription server 118 may be accessed by a URL of “http://podcast.yahoo.com” while each media server 150 may have a different URL such as “www.abcnews.com” and “www.itunes.com”. The processors 103 may have dedicated URLs or may be devices that can intermittently connect to the Internet 104 and are given temporary URLs by the system through which they connect. In another embodiment, Internet Protocol (IP) addresses for each processor 103, media server 150 and the subscription server 118 are different, indicating that the devices are remote from each other, at least in a logical sense.

The servers 150 include one or more feeds 152, such as RSS feeds, that are accessible through the network 104, such as the Internet as shown. The feeds 152, as will be described in greater detail below, include information about the feed (series information) as well as information about the various media files 154 (i.e., episodes) of the feed 152. The feed 152 also identifies the media files 154 so that they can be retrieved by a subscription manager on a processor 103. The media file 154 may reside on the media server 150 with the feed 152, or may be located on yet another server 156 that is, in fact, remote from the podcast server 150 with the feed 152.

As illustrated in FIG. 1, each user's processor 103, the subscription server 118 and media servers 150, as well as the other servers 130, 156 are communicatively connected via the Internet 104. In alternate embodiments, different components of the system may be communicatively coupled differently, for example each may be coupled directly to each other wirelessly or by a local or wide area network (WAN) or the like. Additionally, functional components can be distributed so that certain functions of the search engine 172 may be performed at subscription server 118, or distributed in modular fashion for operation at various locations throughout the system 100. Thus, the description herein of a function or component being associated with a particular device or component or location is merely one possible embodiment.

The search engine 172 also provides users with additional functionality and convenience. The user interface provided by the search engine 172 to the user's processor 103 allows the user to subscribe to a displayed feed (via a subscribe button), listen to an episode of a displayed feed (via listen button), and obtain the complete information on the feed (via clicking on the hyperlinked title) from the same interface. A user need not know where the feed resides on the Internet and need only to interact with the search engine's user interface to perform these actions. Furthermore, the user does not need to explicitly direct his computer to access the publisher's site to subscribe, listen or obtain additional information on a feed.

The system 100 also includes an advertisement insertion system 180. In the embodiment shown, the advertisement insertion system 180 receives requests for media files 154; determines if an advertisement should be provided with the media file 154; prepares a response to the request, including the media file 154 requested and an advertisement if applicable; and transmits the response to the requesting device 103, 150, 118 or some other designated receiving device 103, 150, 118.

In an embodiment, the advertisement insertion system 180 may be implemented as a separate, remote system that can be accessed by any server or processor connected to the network 104. In an alternative embodiment, the advertisement insertion system 180 may be implemented as part of a media server 150 or a subscription server 118. In yet another embodiment, various components of the advertisement insertion system 180 may be separated and distributed among the media servers 150, subscription server 118 and processors 103 in a way the functions of the advertisement insertion system 180 are performed even though no discernable single location on the network can be identified as the advertisement insertion system 180.

The advertisement insertion system 180 provides advertisements for use with media files. The advertisement insertion system 180 may directly or indirectly interact with the various servers and processors shown in FIG. 1, depending on the implementation. For example, in an embodiment, the advertisement insertion system 180 may be adapted to interact only with media servers 150 as part of the media servers' 150 handling of requests for media files 154 and, thus, never directly interacting with consumers' processors 103. In an alternative embodiment, consumer requests for a media file 154 may be directed initially to the advertisement insertion system 180, such that the consumers' processors 103 never directly interact with a media server 150 that uses the advertisement insertion system 180 to provide advertisements.

In an embodiment, the advertisement insertion system 180 selects and inserts advertisements into media files or streams of media data. The advertisement insertion system 180 is designed to work with media files that were created with information identifying where in the media data of the media file an advertisement should be inserted and also with media files created without concern for inserting advertisements at a later time. The advertisement insertion system 180 further tracks the advertisements inserted into or provided with media files. From this information, the advertisement insertion system 180 is then able to bill advertisers and to credit media file publishers.

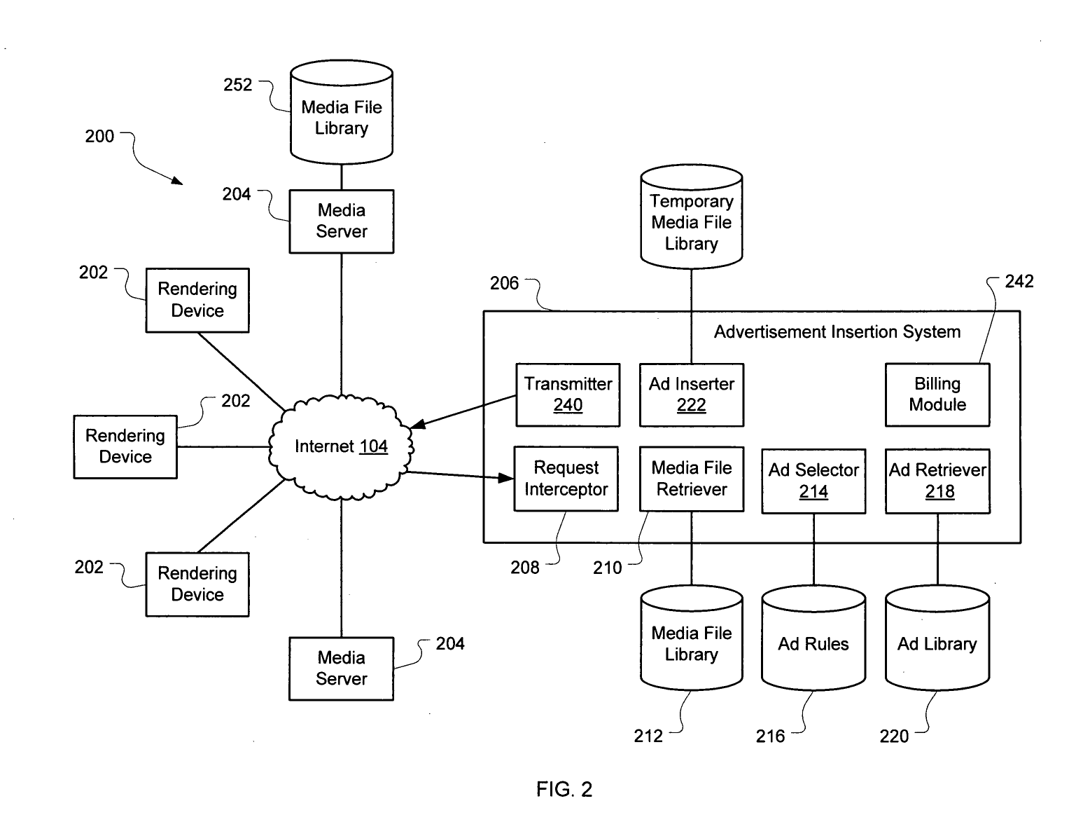

FIG. 2 is an illustration of an exemplified embodiment of an architecture for an advertisement insertion system. In the architecture 200, consumers' processors, in the form of rendering devices 202, and media servers 204 communicate with the advertisement insertion system 206 via a network such as the Internet 104. In the embodiment shown, the advertisement insertion system 206 receives requests for media files; may make a determination of whether an advertisement should be provided with the media file; prepares a response to the request, including the media file requested and an advertisement if applicable; and transmits the response to the requesting device or some other designated receiving device. The response, when rendered, results in the media file and the advertisement being rendered in a predetermined sequence as if the advertisement was originally included in the media file when the media file was created even though the advertisement may have been independently created later or earlier than the media file by a different party.

The example embodiment shown in FIG. 2 illustrates the functions of the advertisement insertion system 206 as separate modules. Although not required, the invention is described for convenience in the general context of functional program modules, which may or may not correspond to specific computer-executable instructions that may be executed by a computer, such as a client workstation or a server. Generally, program modules include routines, programs, objects, components, data structures and the like that perform particular tasks or implement particular abstract data types. Although discussed as separate and distinct modules, one skilled in the art will realize that depending on the implementation choices made during development, some or all of the various modules may combined or further divided into independent sub-modules without changing the overall functionality of the embodiment. In additional, as discussed above in alternative embodiments some or all of the modules described may be distributed throughout other computing devices on the network 104.

The advertisement insertion system 206 is provided with a request interceptor 208 for receiving requests from remote computing devices such as rendering devices 202 and media servers 204. In an embodiment, the requests are requests for media files that are handled by the advertisement insertion system 206. The request interceptor 208 may receive requests directly from the rendering device, i.e., the requests are addressed to the advertisement insertion system 206, or indirectly from other computing devices, i.e., the request is forwarded to the advertisement insertion system with or without the rendering device's knowledge. In an alternative embodiment, additional request interceptor 208 may be implemented on a remote system in order to intercept and forward requests for specified media files to the advertisement insertion system 206.

The request interceptor 208 receives requests and determines if an advertisement should be inserted into a response to the request. In an embodiment, the request interceptor 208 inspects the request and, based on the information in the request such as the requestor's identity, the source of the request, the time of the request and the media file being requested, the request interceptor 208 makes its determination. For example, the request interceptor 208 may maintain a list (not shown) of media files for which advertisements should be provided. The request interceptor 208 may also access and retrieve additional information, such as maintained in a user database 170 or a feed database 174, as part of the determination process. In an alternative embodiment, the request interceptor 208 may not make any determinations and may treat all requests the same.

The advertisement insertion system 206 in the embodiment shown also includes a media file retriever 210. The media file retriever 210 retrieves media files identified in the request. In an embodiment, the media file retriever 210 may retrieve files from a media file library 212 maintained by or otherwise accessible to the advertisement insertion system 206. In an alternative embodiment, the media file retriever 210 may request and retrieve files from a remote media file library 252 maintained by a media server 204. In yet another embodiment, if the request was originally provided by a media server 204, the media file may have been provided with the request, in which case the media file retriever 210 may simply access the media file with the request.

The advertisement insertion system 206 also includes an advertisement selector 214. The advertisement selector 214 selects the advertisement or advertisements that are to be provided with the responsive media file. In an embodiment, the advertisement selector 214 accesses a set of ad rules 216 as part of the selection process. The selection may be based on many different factors including the contents of the received request and may involve the accessing and retrieval of additional information, such as maintained in a user database 170 or a feed database 174. For example, advertisements (or “ads” for convenience) may be selected on geographical location of the requestor, such information being obtainable by comparing a request's header information with a DNS server directory. Ads may be selected based on such things as the demographic information or tag history of the user making the request, such information being obtainable from a user database 170. Ads may further be selected based on the media file requested or the capabilities of the rendering device that the media file will be rendered by. The reader will understand that any basis and information may be used to select a particular ad.

In yet another embodiment, ad rules 216 may include rules that an advertisement be provided only with a media file associated with one or more tags. Rules of this kind allow ads to be rendered based on consumer-supplied tags that are associated with the media file. In this way, although the advertisement is automatically selected by the advertisement insertion system, the actual selections may vary over time as the tag information associated with a media file changes over time in response to receipt of additional consumer-supplied tags. Thus, consumer-supplied tags are yet another basis upon which an advertisement may be selected.

In a podcast specific embodiment, ad rules 216 may include rules based on what series a media file is associated with, e.g., the media file is an episode of a specific feed. Thus, advertisements may be automatically inserted based on the podcast allowing an advertiser to place advertisements in each episode of an entire podcast for a period of time.

After the ad is selected, an advertisement retriever 218 is provided to retrieve the selected ad. In the embodiment shown, the advertisement insertion system 206 is in communication with an advertisement library 220. The advertisement library 220 may be a local mass storage device containing the advertisements selectable by the advertisement insertion system 206. Alternatively, based on the ad or ads selected, the advertisement insertion system 206 may access one or more remote advertisement libraries 220 maintained by advertisers or advertisers' representatives. The ad retrieved may itself be in the form of a media file or may be media data in a form ready for insertion into a file or a response.

The advertisement insertion system 206 includes an advertisement inserter 222 that combines the media file and the advertisement. The combination may include adding some media data from the advertisement to the media file, creating a container for the advertisement and media file, or creating a new media file that is some combination of media data from the media file and the advertisement.

As described in greater detail below, in an embodiment a container, which may itself be a renderable media file containing the ad and the media file, is created by the advertisement inserter 222. The advertisement inserter 222 inserts the advertisement, or media data therefrom, and some or all of the data from the media file into the container. The advertisement may be inserted so that it is rendered before the media file is rendered, after the media file has been completely rendered, or at some point within the media file such that the media file is interrupted by the advertisement.

In another embodiment, the advertisement inserter 222 may create a response message that includes the advertisement, the media file and some directive to the ultimate rendering device to render the advertisement at a certain point relative to rendering the media data of the media file.

In a streaming embodiment, the advertisement inserter 222 may be responsible for creating the stream of media data and thus dictate at what point in the stream the media data from the advertisement should occur relative to the media data from the media file.

In yet another embodiment, the rendering device may already have the media file and the advertisement inserter 222 may then create a response that consists only of a selected advertisement and/or a directive to a rendering device. The directive may be a command identifying a location to insert the selected advertisement. Alternatively, the directive may be a link to an advertisement selected by the advertisement selector 214. Such an embodiment may be used when a rendering device already has the media file and the media file includes information identifying where an advertisement is to be rendered, in which case the rendering device only needs to obtain an advertisement.

The advertisement insertion system 206 is provided with a transmit module 240 that packages the response, be it a data stream or a discrete file, for transmission to the appropriate destination. For example, the response may be packaged into an transport structure compliant with a communication protocol, such as HTTP, the SMTP, TCP/IP or PPP.

The advertisement insertion system 206 further includes a tracking and billing module 242. The tracking and billing module 242 maintains records of what ads were provided with what media files and to whom. In addition, other information may also be recorded such as the requestor's demographic, the requestor's e-mail address or other identifying information, and the source of the media file. The tracking and billing module 242 may automatically generate an electronic or paper invoice to advertisers based on the current contract between the advertiser and the operators of the advertisement insertion system. The tracking and billing module 242 may automatically generate an electronic or paper payment, reward or credit to the publishers or owners of the media files with which the advertisements are provided. Such payments or credits may also be determined based on a current contract between the publisher and the operators of the advertisement insertion system.

Note that embodiments of the system described above allow advertisements to be provided for media files in real time without a direct prior interaction between the media file publisher and the advertiser. In an embodiment, an advertiser may interact with the advertisement insertion system to identify contract terms, ad rules and provided access to the advertiser's advertisements. The advertiser's advertisements are then automatically provided in accordance with the contract terms and ad rules with future media file downloads and render requests that are handled through the advertisement insertion system.

Likewise, the publisher need only interact with the advertisement insertion system as necessary to provide access to the media files conforming the requirements of the advertisement insertion system. This may include routing media file requests to the advertisement insertion system or installing some or all of the advertisement insertion system's software on the publisher's media servers. This may also include the insertion of advertisement markers in the media files as described below. However, after the publisher has met the requirements, advertisements are then automatically provided by the advertisement insertion engine and the publisher need never negotiate with any advertisers directly.

FIG. 3 is an exemplary user interface 300 of an exemplary media file search engine as it would be displayed on a browser of a processor 103 according to one embodiment of the present invention. In the embodiment shown, the graphical user interface 300 is a podcast search engine capable of searching for podcasts and media files that are episodes of podcasts. One skilled in the are will understand that this is but one example of a graphical user interface, whether server generated or generated by a rendering device, from which a user may find and request a media file to be rendered.

The graphical user interface 300 (GUI) includes several areas within the interface, each containing one or more user interface elements. In one embodiment, the GUI 300 is the “home” page of the feed search engine 172 that is displayed to processors 103 when the search engine 172 is accessed via a browser on the processor 103.

The GUI 300 includes a podcast search area 302 within which the user can enter search criteria for podcasts. The search is initiated by a user command delivered via the “search” button 308. Via the drop down box 306 associated with the search field 304 a search can be limited to searching for only series, searching for only episodes or searching for both series and episodes that match the criteria.

The GUI 300 also includes an area 310 titled “New and Noteworthy,” a “staff picks” area 312, and a podcast recommendations area 314, as well as other areas for finding podcasts using tags. Within these areas, various podcasts are listed (such as for example the “GameSpot” podcast 350) or displayed. Associated with each podcast is displayed a “listen” button 330 and a “subscribe” button 332. The subscribe button 332 causes the processor 103 to subscribe to the podcast associated with the button 332.

The listen button 330 causes the most recent episode of the identified series to be downloaded to the user's processor 103 and rendered (e.g., displayed if text, or played with the appropriate media player if audio or video content) to the user by the processor's media player. In an embodiment, user activation of the listen button 330 results in the execution of a server-based media player that streams the appropriate media file the user's browser for rendering in a specialized podcast user interface.

In an embodiment, user selection of the listen button 330 initiates an advertisement insertion system. In one embodiment, a user selection of the listen button 330 causes the user's computing device to transmit a request for the associated media file of the episode. The request generated by the listen button 330 may include additional information derived from the GUI 300 or the user's processor 103 that is usable by the advertisement insertion system for selecting and providing an advertisement with the response containing the media file. For example, the request may include information identifying the user to the advertisement insertion system or the subscription server, information identifying the capabilities of the user's processor, and information regarding advertisements already received by the processor.

The request, as determined by the listen button 330, may be transmitted to the advertisement insertion system directly, or indirectly via transmission to the subscription server or a media server first where the request is intercepted and passed to the advertisement insertion system.

Note that the GUI 300 allows the user to subscribe to a displayed feed (via a subscribe button), listen to an episode of a displayed feed (via listen button), and obtain the complete information on the feed (via clicking on the hyperlinked title) from the same interface 300. A user need not know where a feed or media file resides on the Internet. Furthermore, the user does not need to access the publisher's site to subscribe, listen to a media file, or obtain additional information on a feed.

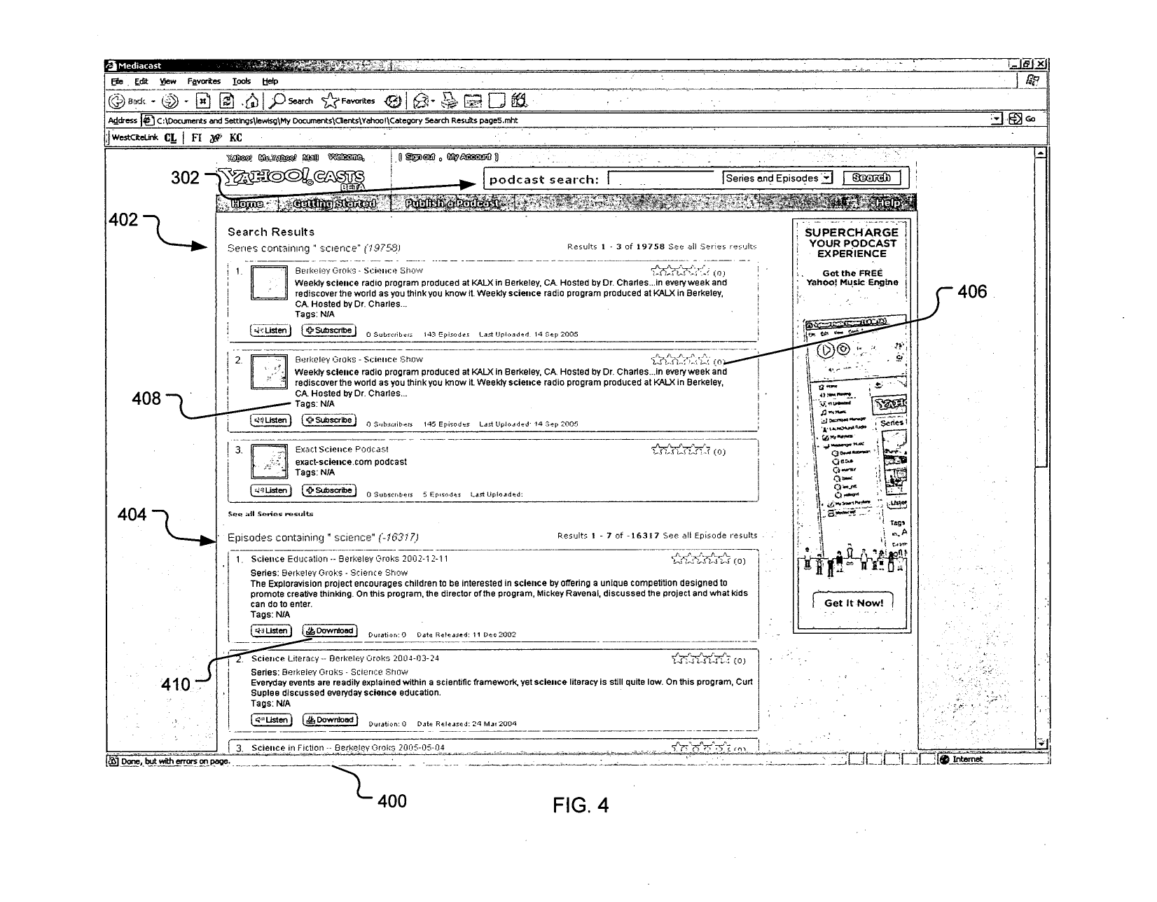

FIG. 4 is an exemplary user interface 400 showing the results of a podcast search according to an embodiment of the present invention. In the search results GUI 400 is divided into several areas including a search area 302 at the top of the GUI 400.

One area 402 shows the series that were returned as matching the search term “science.” In the GUI 400, the term “science” is shown in bold face to assist the user in identifying where the term was found.

The series results area 402 provides for each series listed the series title, description and image from the feed. In addition, a rating for each series as previously described is provided from the feed database. In addition to the rating “stars”, the rating also include a number of users display 406 that have rated the podcast to give the user additional information about the potential quality of the podcast. Listen and subscribe buttons are also provided allowing the user to listen to or subscribe to any listed series with a single command. An additional element in the listing 402 is a tag display 408 listing the tags that users have associated with the series. The tags are obtained from the feed database 174.

A user interface element is provided on the GUI 400 allowing the user to “view all series results.” Likewise another user interface element is provided on the GUI 400 allowing the user to “view all episode results.”

The episode results area 404 includes substantially the corresponding information for episodes as shown in the series results area 402. The episode results area 402 provides for each episode listed the episode title, the series title, and the episode description. In addition, a rating for each episode as previously described is provided from the feed database. In the embodiment shown, none of the episodes have been rated so no stars are filled in. In addition to the rating “stars”, the rating also include a number of users display 406 indicating the number of users that have rated the episode to give additional information about the potential quality of the episode's or feed's rating. Listen buttons and download buttons 410 are also provided allowing the user to listen to or download to any listed episode with a single command. An additional element in the listing 402 is a tag display 408 listing the tags that users have associated with the individual episode. The tags are obtained from the feed database 174 information associated with the episode.

In the embodiment, series titles and episode titles are user interface elements in the form of links that, when selected by a user such as via a mouse click on the link, open a series description page or an episode description page. These description pages include additional and more detailed information regarding the associated feed or episode.

In an embodiment, user selection of the listen button initiates an advertisement insertion system as described above. In addition, user selection of the download button may also initiate advertisement insertion system, causing the advertisement insertion system to provide the associated media file and advertisement to be transmitted to the user's processor.

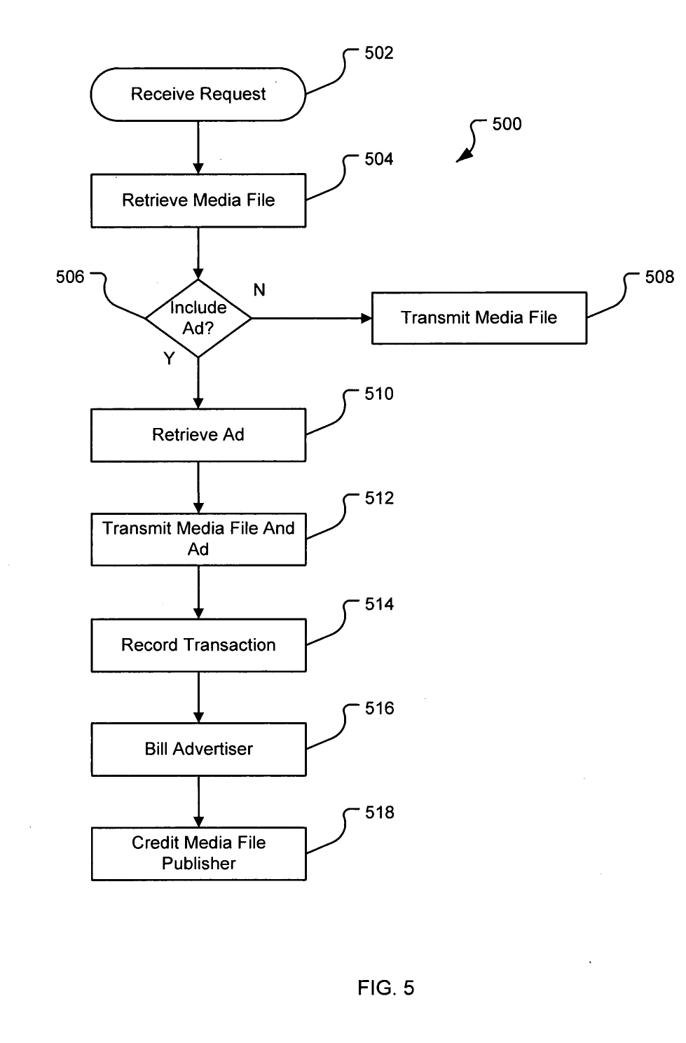

FIG. 5 is a flowchart depicting an embodiment of a method for providing an advertisement with a media file so that the two are consecutively rendered in a predetermined sequence. In the embodiment 500, the method starts when a request is received in a receive request operation 502. The request may have been directed at the receiving computing device or may have been intercepted and rerouted from another location to the advertisement insertion system. The request may or may not be received from the same computing device that the response is ultimately transmitted to in transmission operation 512.

The request is inspected and, if it is a request for a media file, the media file is retrieved in a retrieve media file operation 504. The media file may be retrieved from a local media file database or library, as would be in the case in an embodiment in which the advertisement insertion system is implemented on a media server. Alternatively, the media file may have to be requested and received from a media server remote from the advertisement insertion system. In yet another embodiment, the media file may have been provided with the request. In this case, the retrieve media file operation 504 may only require that the media file be extracted from its transport package.

In an alternative embodiment, the request may be a request for an advertisement to be inserted into the media file at a remote location such as at the media server or the user's processor. In this case, the method 500 proceeds the determination operation 508.

Next, a determination operation 508 determines if an advertisement should be provided with the response to the request. This determination may include inspecting the request, obtaining additional information from remote and local databases, and comparing any relevant information to a set of rules for determining whether to include an ad. If the determination operation 508 determines that no ad should be provided with the response, a transmit media file operation 508 is performed and the requested media file is transmitted to the receiving device as directed by the request.

If determination operation 508 determines that an ad should be provided, a retrieve ad operation 510 is performed. As described in greater detail below, the retrieve ad operation 510 may include selecting one or more advertisements from a group of advertisements. In an embodiment, the retrieve ad operation 510 may access a set of ad rules as part of the selection process. The selection may be based on many different factors including the contents of the received request and may involve the accessing and retrieval of additional information, such as a user database 170 or a feed database 174.

After the ad is selected, the retrieve ad operation 510 retrieves the selected ad. The ad may be retrieved from a local or remote location, such as an advertisement library 220. The ad retrieved may itself be in the form of a media file or may be media data in a form ready for insertion into a file.

Next the media file and the advertisement are transmitted to the receiving device as directed by the request. As discussed above and in greater detail below, in an embodiment the transmission may include a media file and a separate advertisement file. In another embodiment, the transmission may include a single file containing combined media data taken from the media file and the ad. In yet another embodiment, the transmission may be a stream of media data containing media data taken from the media file and the ad.

The method 500 also includes a record transaction operation 516 in which the particulars of the request and response are recorded. The transaction operation 516 creates a record of what ads were provided with what media files and to whom. In addition, other information may also be recorded such as the requestor's demographic, the requestor's e-mail address or other identifying information, and the source of the media file.

A bill advertiser operation 516 is performed in which the advertiser is billed for the delivery of the advertisement to the consumer. The bill advertiser operation 516 may periodically and automatically generate an electronic or paper invoice to advertisers based on the current contract between the advertiser and the operators of the advertisement insertion system.

A pay publisher operation 518 is also performed in which the publisher or owner of the media file is credited or otherwise remunerated for the use of the media file as a vehicle for delivery of the advertisement to the consumer. The pay publisher operation 518 may automatically generate an electronic or paper payment or credit to the publishers or owners of the media files with which the advertisements are provided. Such payments or credits may also be determined based on a current contract between the publisher and the operators of the advertisement insertion system.

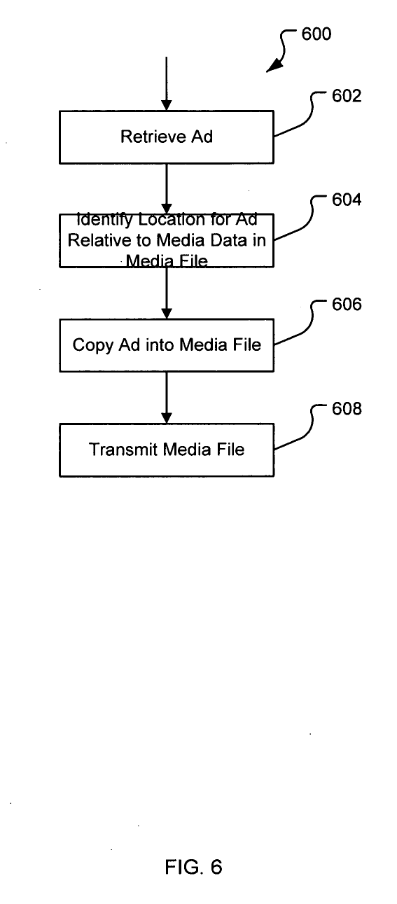

FIG. 6 is a flowchart depicting in greater detail an embodiment of a method for retrieving an advertisement and providing it with a media file in accordance with the present invention. In the embodiment 600, media data from the retrieved ad is inserted into the requested media file, thereby creating a new version of the media file now including the original media data and the advertisement's media data.

In the embodiment 600, an advertisement is retrieved in a retrieve ad operation 602, such as described above with reference to FIG. 5. In order to insert the media data from the ad, an identify ad location operation 604 is performed. The identify ad location operation 604 identifies a location within the media file where the ad should be located. The location may be identified by searching the media file for information, generically referred to as an advertisement marker, that identifies at what location relative to the media data of the original media file the media the media data of the advertisement should be rendered.

In an embodiment, the media file was created by the publisher in anticipation of an advertisement being provided for rendering with the media file at a later time. Thus, the media file may itself contain an advertisement marker of some kind.

In an embodiment, an advertisement marker may take the form of metadata. The metadata may be part of the media file, or there may be metadata associated with the media file that is accessible to the advertising insertion system for use in the identify ad location operation 604. The metadata may take any form interpretable by the advertisement insertion system, such as a location tag, a time stamp or some other interpretable data identifying a location within the media file. The metadata may be within the media file as part of a set of metadata as is provided in many currently used media file formats such as MPEG and MP3. Alternatively, the metadata or location information may be obtained from a data store, such as may be maintained by the publisher of the media or by central ad metadata data store maintained by the advertisement insertion system. In yet another embodiment, the metadata may be provided with the request, if the request is transmitted from a media server to the advertisement insertion system.

In an alternative embodiment, the identify ad location operation 604 may look for an advertisement marker that comprises actual, renderable media data within the media file, such media data being identifiable upon inspect as indicating that an advertisement should be inserted or rendered at this point in the rendering of the media data. An advertisement marker made up of renderable media data may take the form of a short tone in a certain frequency range, or a specific color or set of color changes at a specific location on a video display. The advertisement marker may be selected so that the odds of the advertisement marker being randomly created in the media file by the producer are very low. In addition, the advertisement marker may be selected so that when rendered, the media data making up the advertisement marker are, for all practical purposes, imperceptible to the consumer. In this way, media files with advertisement markers may be created that are backward compatible with pre-existing rendering devices and the inclusion of advertisement markers does not inhibit the rendering of the media files without advertisements.

In yet another embodiment, the identify ad location may be based on tags associated, via metadata, with various sections of the media file. These tags may be inspected in order to determine the tag density and probable subject matter of different locations within the file. For example, in an embodiment, the metadata may include multiple tags associated with a small subportion of the media file, all of the tags related to a subject, e.g., “football.” The identify ad location operation 604 may inspect this metadata and identify a location based on the location distribution of the football-related tags. Thus, the identify ad location operation 604 may include an analysis of the metadata to identify tags and calculate a location based on the tag density, i.e., the number of tags associated with different locations within the media file.

Alternatively, the identify ad location operation 604 may not look for any advertisement marker but rather may by default place ads in a predetermined location relative to the media data of every media file so that, upon rendering the media file, the ad is rendered in a preferred location relative to the media data of the original media file. For example, the ad may by default be inserted so that it is rendered first, before any of the media data of the original media file, rendered after all media data of the original media file has been rendered, or rendered after some predetermined period of time, such as two minutes into rendering the media data of the original media file.

After the location has been identified, a copy ad operation 606 copies media data from the retrieved ad into the media data of the media to create a new version of the media file. This is referred to as a new version in that the resulting media file retains the identification information of the original media file, perhaps with the only change being that the ad media data has been introduced. In the embodiment, the media data of the new version of the media file now contains all of the media data of the original and at least some of the media data from the ad. If the ad was retrieved in the form of a media file, none, some or all of the metadata in the ad may be copied into the media file as well, depending on the format of the media file.

The media file is then transmitted as directed by the request in a transmission operation 608, such as discussed with reference to FIG. 5.

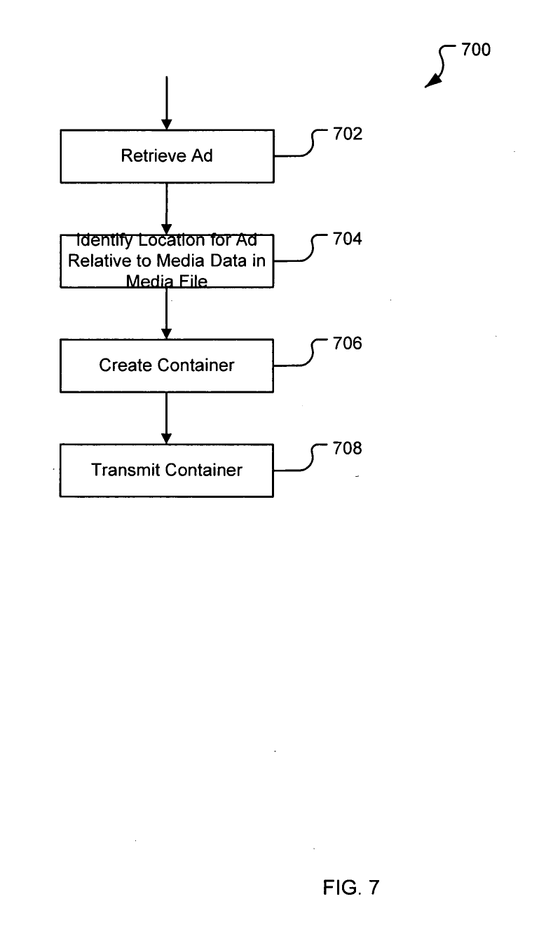

FIG. 7 is a flowchart depicting in greater detail yet another embodiment of a method for retrieving an advertisement and providing it with a media file in accordance with the present invention. In the embodiment 700, a container is created into which some or all of the ad and the requested media file are placed. This may or may not include the creation of a new version of the media file. In addition, the container may or may not be identified as the media file to the destination device.

In the embodiment 700, an advertisement is retrieved in a retrieve ad operation 702, such as described above with reference to FIG. 5. In order to insert the media data from the ad, an identify ad location operation 704 is performed, such as described above with reference to FIG. 6.

A container is then created in a create container operation 706. The container may be created so that it is directly or indirectly interpretable by a rendering device to cause the rendering in the appropriate sequence of media data from the advertisement and the media file. The container may take many different forms, depending on the implementation. For example, in one embodiment the container is best thought of as a simple package that includes the request media file in its entirety, the advertisement and some directive interpretable by the ultimate rendering device to cause the advertisement to rendered at the appropriate point relative to the rendering of the media file.

In an alternative embodiment, the container may be renderable media file containing the media data of the advertisement and the media data of the requested media file, such that when rendered by a rendering device the container renders the media file and also renders the advertisement at the appropriate point relative to the rendering of the media file. Thus, media data from the media file and the advertisement may be copied into the container in create container operation 706.

In yet another embodiment, the container may contain links to the media file and the advertisements and include some directives to the rendering device that cause the rendering device to retrieve the various files or data from remote locations and render them appropriately.

The container is then transmitted as directed by the request in a transmission operation 608, such as discussed with reference to FIG. 5.

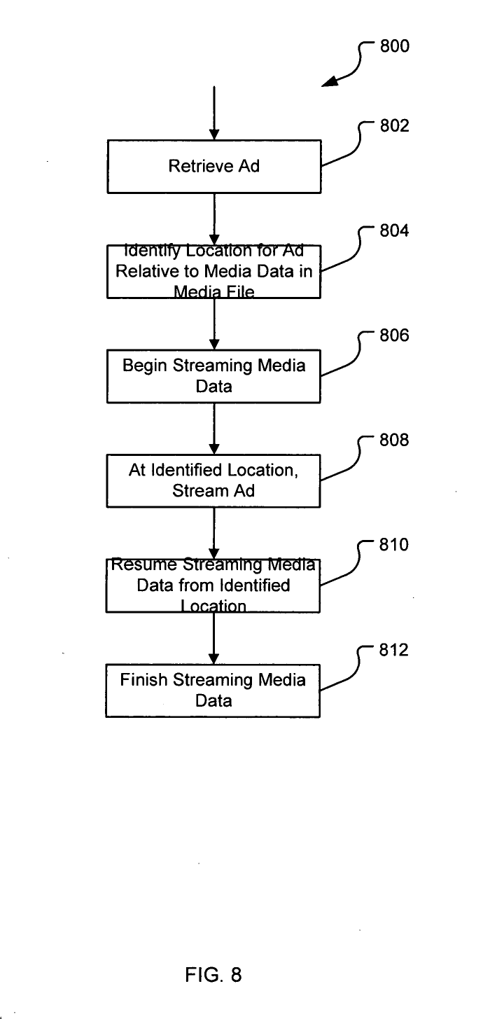

FIG. 8 is a flowchart depicting in greater detail yet another embodiment of a method for retrieving an advertisement and streaming media data from the advertisement and the requested media file in accordance with the present invention. In the embodiment 800, a stream of media data is created into which some or all of the ad and the requested media file are placed, which is then transmitted as directed by the request, such as directly to the rendering device.

In the embodiment 800, an advertisement is retrieved in a retrieve ad operation 802, such as described above with reference to FIG. 5. In order to insert the media data from the ad, an identify ad location operation 804 is performed, such as described above with reference to FIG. 6.

A begin streaming media data operation 806 then initiates the streaming of media data. Depending on where relative to the media data of the requested media file the advertisement should be rendered, the initial media data transmitted may be from either the media file or the advertisement. At some point during streaming and in accordance with the results of the identify ad location operation 804, the stream of media data from the requested media file will be interrupted and the media data from the advertisement will be streamed in stream ad operation 808. After the ad is streamed, then the interrupted stream of media data from the requested media file will resume streaming in a resume operation 810. The stream ends at a finish operation 812 when all the appropriate media data has been streamed to the destination.

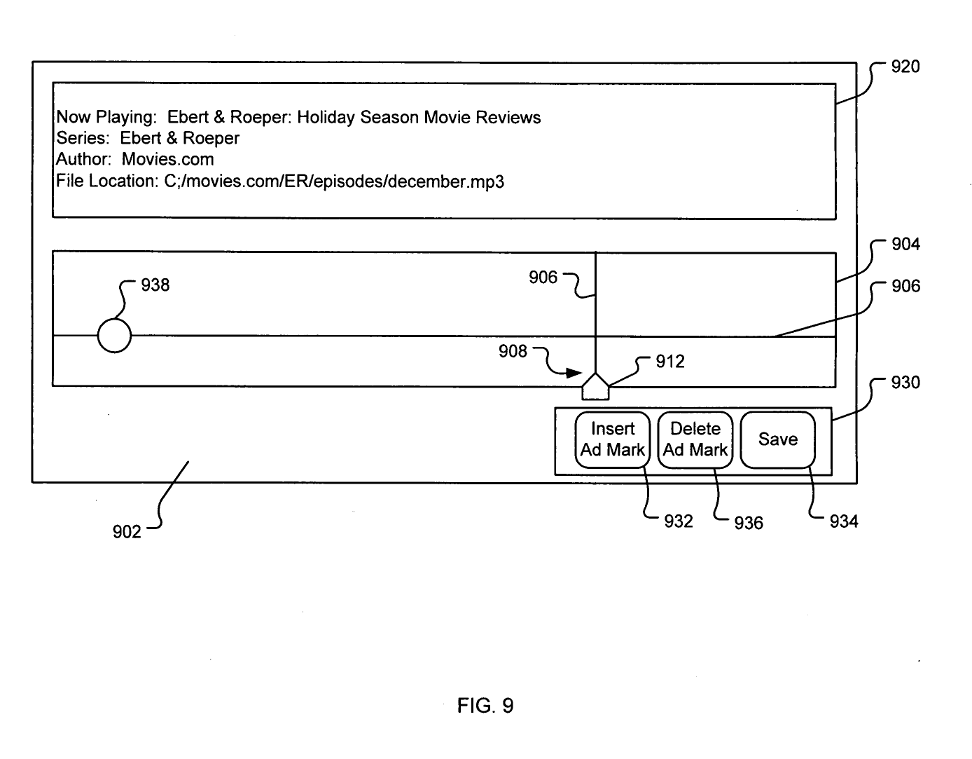

FIG. 9 is an exemplary user interface for a media player adapted to insert advertisement markers into audio media files according to one embodiment of the present invention. In a video embodiment, the media player GUI 900 may be further provided with a video display area (not shown).

In the embodiment shown, the media player may be a “web player” in that the media player GUI 900 is generated by the subscription server and transmitted to the user's processor, for example as a page of .HTML or .XML, for rendering to the user via the processor's browser. The media player GUI 900 may be generated and transmitted in response to a user selection of a place ad in media file button exposed on another GUI generated by a local or a remote advertisement insertion system. The generated media player GUI 900 may then include the location information necessary for the processor to access the associated media file. Alternatively, the media file may be selected using File and Edit controls (not shown) on the GUI 900.

The media player GUI 900 includes a media file information area 920. The area 920 includes information such as the title of the media file, if the media file is a podcast episode, the series to which the episode belongs, and the author. In addition, the embodiment of the media file information area 920 shown identifies the location of the media file currently being edited. Alternate embodiments of media players provide different amounts of information and user interface elements to the user.

The media player GUI 900 includes a timeline display 904 of the media data in the media file being edited. The timeline display 904 includes a timeline 906 and a current render location control 908. The current render location control 908 includes a location line 910 that intersects the timeline 906 at the current render location and a user-selectable location slider control 912.

The media player GUI 900 includes a render controls area 902 containing various media player controls such as a volume control, a mute button, play/pause button, a next button, a last button and a playback speed slider control. The user-selectable controls allow the user to control rendering of the media data in the media file so that the user may render the media file in order to assist the user in the selection of a location to insert an advertisement marker.

In the media player GUI 900 shown, the GUI 900 differs from typical media players in that it also includes an advertisement marker management area 930. This area 930 allows the user to insert an advertisement marker that identifies a location in the media file for future insertion of an advertisement by an advertisement insertion system, such as by the method 600 described with reference to FIG. 6. Thus, a user via the media player GUI 900 can both listen to/view a media file and, while rendering, select a location for an ad to be placed in the media file.

The advertisement marker management area 930 in the embodiment shown includes an insert advertisement mark control 932. User selection of the insert advertisement mark control 932 results in an advertisement mark being associated with the media file. The advertisement mark will identify a location corresponding exactly or approximately to the location of the current render location control 908 when the user selection is received. The actions performed in response to a user selection of the insert advertisement mark control 932 will vary depending on the embodiment of advertisement mark used. For example, in an embodiment in which the advertisement mark is metadata stored in a media file or associated with a media file in a data store, the insert advertisement mark control 932 will cause the appropriate metadata to be created. Upon further user selection of the save control 934, the metadata may then be saved so that subsequent inspection of the media file in an identify ad location operation will find the advertisement mark. This may include saving a new version of the media file.

As another example, in an embodiment in which the advertisement mark is recognizable media data stored in media data of a media file, the insert advertisement mark control 932 will cause the appropriate media data to be created. Upon further user selection of the save control 934, some media data corresponding to the location of the user selection of the insert advertisement mark control 932 may be overwritten by the advertisement marker media data. The media file with the advertisement marker may then be saved so that subsequent inspection of the media file in an identify ad location operation will find the advertisement mark. The selection of the media data to be overwritten may be made in order to render the media data as unobtrusive as possible, so that the advertisement marker when rendered is substantially imperceptible to a consumer of the media file. This may be done by making the tone or video element so short in duration when rendered that the majority of consumers cannot perceive the marker. Alternatively, the advertisement marker may be an obvious transition.

In the embodiment shown, the user of the GUI 900 is shown a visual representation 938 of an ad marker on the timeline 906. This visual representation 938 is presented to the user in response to a user selection of the insert advertisement mark control 932. In an embodiment, the visual representation 938 may be selected by a user via a pointing device and then deleted by a user selection of the delete ad mark control 936. Furthermore, the visual representation 938 allows a user to inspect media files that already are provided with ad markers and edit the existing ad marks.

In an alternative embodiment, the user may associated information with the ad marker, such as via a pop up screen (not shown) displayed in response to a user selection of the insert ad marker or of a visual representation 938 of an ad marker. Through the pop up screen, the user may be able to provide information, such as ad rules, limiting what types of ads may be provided for the media file in the future. For example, the use may select a maximum allowable advertisement length or a set of allowable advertisements or advertisers. This information may be stored in the advertisement marker itself or may be stored in a rules set and associated with the media file.

In an alternative embodiment, the advertising marker may identify an advertisement to be used in addition to identifying the location for the advertisement. The advertisement identified may be a file name or may be an abstraction that can be interpreted by a rendering device or an advertisement insertion system to identify a specific advertisement. For example, the advertisement identifies may identify an advertisement category, which is then interpreted by the advertisement insertion system to retrieve an advertisement based on the category definition. Examples of categories include a primary sponsor and a secondary sponsor in which a primary sponsor may be charged more for an advertisement based on its location in the media file while a secondary sponsor may be billed less.

Embodiments of the present invention are suitable for use by media file creators. For example, an embodiment of a GUI, such as GUI 900 of FIG. 9, may be incorporating into a media file creator system so that media files, when created, include metadata identifying the locations where advertisements should be inserted when the media files are rendered. Such metadata may include information that causes the advertisement to be retrieved from some advertisement provision system, thus allowing different advertisements to be rendered upon different renderings of the media file without changing the media file after its initial creation by the creator.

Embodiments of the present invention are also suitable for use by consumers of media files for associating information with locations within a pre-existing media file with or without changing the media file or creating a derivative work of the media file. Consumers, using a media player with an embodiment of a GUI such as the GUI 900 in FIG. 900, can create metadata that inserts additional content for any desired purpose, such as to add additional description or commentary, to add a rating associated with the location, or to associate additional information, such as a tag, with the location to be used later by the consumer.

Those skilled in the art will recognize that the methods and systems of the present invention within this specification may be implemented in many manners and as such is not to be limited by the foregoing exemplary embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible. For example, the above discussed methods could be used to provide multiple advertisements with a single media file. The system may be implemented so that each rendering of a media file, even a media file already stored locally on a rendering device, results in the rendering of a new ad for which the publisher is rewarded and the advertiser is billed.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present invention covers conventionally known and features of those variations and modifications through the system component described herein as would be understood by those skilled in the art.

What is claimed is:

1. A method comprising:
receiving, from a requesting device, a request for a media file;
determining, based on the request, that an advertisement should be transmitted with the media file and that the media file does not include the advertisement; and
transmitting the media file and the advertisement to the requesting device so that media data of the media file and media data of the advertisement are rendered in a predetermined sequence.

2. The method of claim 1 wherein transmitting further comprises:
inserting media data from the advertisement into the media file.

3. The method of claim 1 wherein transmitting further comprises:
creating a container;
copying media data from the advertisement into the container;
copying media data from the requested media file into the container; and
transmitting the container to the requesting device.

4. The method of claim 3 wherein the container is presented to the requesting device as the requested media file.

5. The method of claim 3 wherein the copying operations further comprise:
copying media data from the advertisement into the container so that the advertisement is rendered before the media data from the media file is rendered.

6. The method of claim 1 further comprising:
recording that the advertisement was transmitted to the requesting device;
billing an advertiser associated with the advertisement a first amount of money; and
crediting a publisher associated with the media file a second amount of money.

7. The method of claim 3 further comprising:
searching the media file for an advertisement marker; and
inserting media data from the advertisement into the container at a location based on the advertisement marker.

8. The method of claim 7 wherein the advertisement marker is within media data of the media file at a predetermined advertisement location in the media file and inserting further comprises:
inserting media data from the advertisement into the media file at the predetermined advertisement location.

9. The method of claim 1 wherein the transmitting operation comprises:
transmitting an advertisement render command, the advertisement command causing the requesting device to render the advertisement.

10. The method of claim 9 wherein the advertisement render command is inserted within media data of the media file at a location within the media file that the advertisement is to be rendered.

11. The method of claim 9 wherein the advertisement render command is metadata associated with the media file.

12. The method of claim 7 further comprising:
searching the media data of the media file for the advertisement marker at a predetermined advertisement location; and
copying media data from the advertisement into media data of the media file at the predetermined advertisement location within the media data of the media file.

13. The method of claim 1 further comprising:
selecting an advertisement from an advertisement library based on the request.

14. The method of claim 1 wherein transmitting further comprises:
streaming media data of the media file to the requesting device, the streamed media data for rendering as the media data is received; and
streaming media data of the advertisement to the requesting device.

15. The method of claim 14 further comprising:
streaming media data of the advertisement to the requesting device before streaming media data of the media file to the requesting device.

16. The method of claim 14 further comprising:
streaming media data of the advertisement to the requesting device before and after streaming media data of the media file to the requesting device.

17. The method of claim 14 further comprising:
streaming media data of the advertisement to the requesting device after streaming media data of the media file to the requesting device.

18. The method of claim 14 further comprising:
interrupting the streaming of media data of the media file to the requesting device based on an advertising marker;
streaming media data of the advertisement to the requesting device; and
resuming the streaming of media data of the media file to the requesting device after streaming media data of the advertisement to the requesting device.

19. The method of claim 7 wherein the advertisement marker is recognizable media data in media data of the media file.

20. The method of claim 19 wherein the advertisement marker is media data representing an predetermined audio tone.

21. The method of claim 19 wherein the advertisement marker is video media data representing a predetermined color at a specified location within a rendered video representation of the media data.

22. The method of claim 7 wherein the advertisement marker is metadata stored as part of the media file.

23. The method of claim 21 wherein the advertisement marker is advertisement location metadata associated with the media file identifying a location within the media file to insert the advertisement.

24. The method of claim 23 wherein the metadata is stored within the media file.

25. The method of claim 23 wherein the metadata further identifies the media file and is stored in a metadata database accessible at a location remote from the media file.

26. A system comprising:
a request interception module adapted to receive a request for a media file and to inspect the request to determine if an advertisement is associated with the media file;
a media file retrieval module adapted to retrieve the media file identified by the request;
a transmission module adapted to create a response to the request, the response including the media file and, if an advertisement is associated with the media file; the associated advertisement, and to transmit the response, the response when rendered resulting in the rendering of the media file and the advertisement in a predetermined sequence.

27. The system of claim 26 wherein the request interception module is adapted to receive a request from a rendering device and the transmission module is adapted to transmit the response to the rendering device.

28. The system of claim 26 further comprising:
an advertisement insertion module adapted to determine where in the media file to insert the advertisement and to create a response media file, the response media file renderable by the rendering device and including media data from the media file and media data from the advertisement.

29. The system of claim 26 further comprising:
a media file library containing the media file.

30. The system of claim 29 wherein the media file library is accessible at a first network location remote from the request interception module.

31. The system of claim 26 further comprising:
an advertisement library containing a plurality of advertisements, the plurality of advertisements including the advertisement.

32. The system of claim 31 wherein the advertisement library is accessible at a second network location remote from the advertisement insertion module.

33. The system of claim 31 further comprising:
an advertisement retrieval module adapted to select and retrieve the advertisement from the advertisement library based on information contained in the request.

34. The system of claim 33 further comprising:
a set of advertisement insertion rules including at least one rule dictating the selection of the advertisement from a plurality of advertisements based on information contained in the request.

35. The system of claim 26 further comprising:
a billing module that automatically generates a bill for an advertiser associated with the advertisement.

36. The system of claim 26 wherein the advertisement insertion module generates a stream of media data derived from the advertisement and the media file and the transmitter module transmits the stream.

37. A computer-readable medium having computer-executable instructions for performing a method comprising:
receiving a request for a media file;
determining, based on the request and a set of ad rules, that an advertisement should be transmitted with the media file; and
transmitting the media file and the advertisement to the requesting device.

38. The computer-readable medium of claim 37 wherein transmitting further comprises:
inserting media data from the advertisement into the media data of the media file.

39. The computer-readable medium of claim 37 wherein transmitting further comprises:
creating a container;
copying media data from the advertisement into the container;
copying media data from the requested media file into the container; and
transmitting the container to a destination computing device identified by the request.

40. The computer-readable medium of claim 39 wherein the container is presented to the requesting device as the requested media file.

41. The computer-readable medium of claim 39 wherein the copying operations further comprise:
copying media data from the advertisement into the container so that the advertisement is rendered before the media data from the media file is rendered.

42. The computer-readable medium of claim 39 further comprising instructions for:
searching the media file for an advertisement marker; and
inserting media data from the advertisement into the container at a location based on the advertisement marker.
